(19) United States
(12) Patent Application Publication
(10) Pub. No.: US 2018/0023536 A1
(43) Pub. Date: Jan. 25, 2018

(54) SYSTEM AND METHOD FOR ENERGY GENERATION AND FLUID TREATMENT

(71) Applicant: Dilip Vasantlal BHANUSHALI, Mumbai (IN)

(72) Inventor: Dilip Vasantlal BHANUSHALI, Mumbai (IN)

(21) Appl. No.: 15/527,725

(22) PCT Filed: Nov. 23, 2015
(86) PCT No.: PCT/IB2015/059032

§ 371 Date: May 18, 2017

(30) Foreign Application Priority Data
Nov. 24, 2014 (IN) 3713/MUM/2014

(51) Int. Cl. F03B 13/08; B01F 3/04

(52) U.S. Cl. CPC F03B 13/086; B01F 3/04517; F05B 2210/18; F05B 2220/602

(57) ABSTRACT

The system and method for energy generation along with fluid treatment includes but not limited to aeration, filteration and heat transfer or temperature control. The system may comprise at least one first enclosed chamber. Further plurality of nozzles are configured to allow flow of the fluid into the at least one first enclosed chamber. The system further comprises plurality of second chambers connected to the at least one first enclosed chamber through a network of pipes. Further the system comprises an aerofoil turbine mounted in the plurality of second chambers, wherein the aerofoil turbine is configured to receive a second fluid (example: atmospheric air) via plurality of inlets ports positioned on periphery of the aerofoil turbine.

### FIELD OF INVENTION

The disclosure relates to generation of energy along with fluid treatment, more specifically the disclosure relates to converting energy of fluids in motion into mechanical energy and produce a powerful torque force at the shaft of one or more turbines which can be used to do mechanical work or convert electrical energy along with treatment of contaminated water by means of aeration and treatment of contaminated air by means of scrubbing and treatment of hot air by means of cooling.

### BACKGROUND

Hydro-electric power generation is considered most viable and preferred non-conventional source of energy. The hydro power plant serves two purposes: storing of the water in the reservoir and generating power when discharging the water. Further, the stagnation of water in the reservoir may reduce the oxygen content in the water and Possibly hamper the marine life. Sewage and industrial waste discharged in the water may give rise to bacteria, causing serious health hazard to people surviving on this water.

One of the solution to the aforesaid problem is aeration. In fact aeration is a most important process in waste water treatment plants where almost 60% of power is consumed. But aerating millions of gallons of water flowing out of a dam or in a river is a huge task. It will require huge amount of power and infrastructure and hence will be unviable economically and practically.

The present system and method solves the aforesaid problem by treating millions of gallons of the dam water by means of aeration and simultaneously produce energy which can be supplied to the grid or used in treating additional volume of water.

The present system also reduces power consumption of water treatment plants, air pollution treatment plants and cooling towers because of its ability to regenerate consumed power while treating the entrained as well as entrained fluids.

This summary is provided to introduce aspects related to generation of energy along with fluid treatment and the aspects are further described below in the detailed description. This summary is not intended to identify essential features of the claimed subject matter nor intended for use in determining or limiting the scope of the claimed subject matter. The entrained fluid due to the vacuum created is not limited to atmospheric air. The inlet ports may also be connected to any chamber holding the entrained fluid as well as the motive fluid is not limited to water. The motive fluid can be pressurised steam, compressed air or any fluid under pressure.

In one implementation, a system for power generation and aeration of a fluid is disclosed. The system comprises at least one first enclosed chamber. Further, the at least one first enclosed chamber is connected to a plurality of nozzles. The plurality of nozzles are configured to allow flow of the fluid into the at least one first enclosed chamber. Further, the system comprises plurality of second chambers connected to the at least one first enclosed chamber through a network of pipes. The system further comprises an aerofoil turbine mounted in the plurality of second chambers. The aerofoil turbine is configured to receive or entrain another fluid (e.g. atmospheric air or any gas from a cylinder) via a plurality of inlets ports positioned on periphery of the aerofoil turbine.

In another implementation, a method for simultaneous aeration of fluid and power generation is disclosed. The method comprises carrying a pressurized fluid to inlet port. Further discharging the pressurized fluid into at least one first enclosed chamber through a plurality of nozzles mounted and positioned after the inlet port. The method further comprises generating a partial vacuum in the at least one enclosed chamber. Further, the method also comprises generating a partial vacuum in a plurality of second chambers connected to the at least one first enclosed chamber through a network of pipes. The method further comprises enabling entry of another fluid (e.g. atmospheric air) via a plurality of inlet ports while simultaneously rotating an aerofoil turbine. Further capturing and converting the rotation of the aerofoil turbine for energy generation.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a front view of system, in accordance with an embodiment of the present subject matter.

FIG. 2 illustrates a system for treatment for a motive fluid, in accordance with the present disclosure.

FIG. 3 illustrates a flow chart for the system, in accordance with an embodiment of the present subject matter.

### DETAILED DESCRIPTION

The present subject matter discloses a system and method for power generation in a plurality of stages and aeration of a fluid in order to oxygenate the fluid. Further, to capture heat along with suspended dust particles, viruses, bacteria from atmospheric air, and release clean and cold air.

The present disclosure enables power generation by converting the potential energy of a fluid under pressure to kinetic energy and creating a down draft in order to produce a partial vacuum in plurality enclosed chambers. As the partial vacuum is created, a second fluid (example: atmospheric air) is sucked into the system through plurality of ports to rotate one or more turbines due to its high velocity and volume. This is stage 1 of energy generation.

The entrained fluid (air) further mixes with the motive fluid aerating it with oxygen. The aeration of the motive fluid is achieved due to scrubbing of fine droplets of the motive fluid with entrained air. The velocity of the motive fluid flowing/falling in the ejector chamber increases under influence of the gravity thereby increasing the available energy for extraction. Fluid and air mixture when finally hits a second turbine at an ejector/chamber discharge end; kinetic energy from fluid is transferred to turbine blades while large volume of air passing through the aerofoil blades further increases turbine efficiency. This is stage 2 of energy generation.

After passing through the 2nd stage of energy generation, the motive fluid and the entrained fluid mixture accumulates into an enclosed reservoir wherein the motive fluid and the entrained fluid is segregated. The enclosed reservoir chamber is designed to discharge the motive fluid and the entrained fluid through different ports. The motive fluid leaves the reservoir by means of overflowing port positioned at the base while the entrained fluid is allowed to escape to atmosphere from the top. As volume of the entrained fluid in the reservoir increases, it creates a pressure difference with respect to the atmospheric pressure outside. The increase in volume of the entrained fluid further pressurises the entrained fluid inside the reservoir. Further, the pressured entrained fluid is released to atmosphere through single or multiple aerodynamic ports placed around the circumference or the periphery of a turbine. The high velocity air when released from the reservoir transfers the kinetic energy to the turbine enabling 3rd stage of energy generation.

In another embodiment, the system efficiency is increased by providing one or more exhaust fans or suction blowers placed above the 3rd stage turbine. Since the system works on the venturi principle, the exhaust fans help in reducing back pressure, enabling increase in velocity of the fluid in all stages. Increased velocity of the motive fluid increases the volume of the entrained air thereby improving the aeration quality by transferring more oxygen to fluid. Further, the drag and turbulence created by air molecules in the chambers is reduced by the exhaust fan. Therefore the velocity of fluid and air hitting the second turbine increases too.

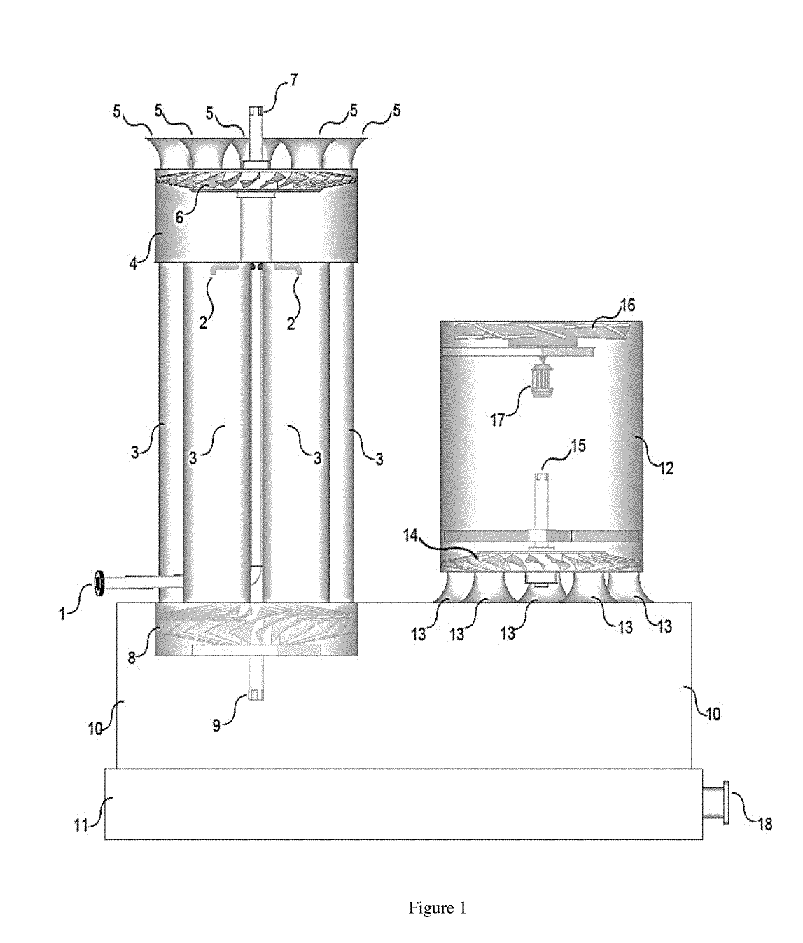

Now referring to FIG. 1, in an exemplary embodiment, a network of pipes carries a motive fluid under pressure. The motive fluid refers to water or sewage fluid from a reservoir or compressed air or compressed steam from a tank. According to the embodiment the pressurized motive fluid is discharged, into at least one first enclosed chamber 3 via at least one first motive fluid inlet port 1. In an embodiment, the at least one first enclosed chamber 3 is preferably cylindrical in shape. The at least one first enclosed chamber 3 herein called as ejector that receive the discharge of the pressurized motive fluid through plurality of nozzles 2. Further, the at least one first enclosed chamber 3 may vary in shape, size, and orientation based on the primary purpose of the system as shown in Table 1.

TABLE 1

| Draft | Water | | | |
|---|---|---|---|---|
| In H2O | Pressure | Chamber Size (Inches) | | |
| Difference | PSIG | 4 | 12 | 60 |
| | | Entrainment of air (CFM) | | |
| 0 | 20 | 68 | 1250 | 41900 |
| 0 | 40 | 108 | 1825 | 65048 |
| 0 | 60 | 125 | 2715 | 81228 |
| 0 | 80 | 163 | 2635 | 91739 |
| 0 | 100 | 202 | 2715 | 111340 |
| 1 | 20 | 0 | 250 | 8380 |
| 1 | 40 | 39 | 913 | 32524 |
| 1 | 60 | 75 | 1329 | 48737 |
| 1 | 80 | 114 | 2108 | 73391 |
| 1 | 100 | 172 | 2308 | 94639 |

Motive Fluid (Water)(GPM)

| | | | | |
|---|---|---|---|---|
| Nozzle flow | 20 | 1.70 | 26.50 | 1109.00 |
| Nozzle flow | 40 | 2.50 | 39.00 | 1558.00 |
| Nozzle flow | 60 | 3.20 | 48.25 | 1945.00 |
| Nozzle flow | 80 | 3.80 | 56.70 | 2245.00 |
| Nozzle flow | 100 | 4.30 | 62.30 | 2490.00 |

The pressurized motive fluid having high volume and high velocity displaces existing air in the at least one first enclosed chamber 3 thereby creating a partial vacuum in the at least one first enclosed chamber 3. In another embodiment more than one enclosed chamber 3 is connected to plurality of second chambers 4 at first end of the plurality of second chambers 4. Further, as volume of air reduces in enclosed chamber 3, partial vacuum is created in the plurality of second chambers 4.

Further, the plurality of second chambers 4 comprises a first aerofoil air turbine 6 mounted at a second end of the plurality of second chambers 4. The first aerofoil turbine 6 is further configured to receive an entrained fluid like atmospheric air via the plurality of entrained air inlet ports 5. The plurality of entrained air inlet ports 5 are positioned close and around an outer edge of aerofoil turbine blades. In another embodiment, cross section area of the plurality of entrained air inlet ports 5 are optimized to accelerate the speed of atmospheric air or entrained air to optimum flow rate and velocity. In large networks and high flow conditions, velocity of entraining air may reach up to 340 m/s or above. The kinetic energy of the entrained fluid (example: atmospheric air) produces rotational motion in the first aerofoil turbine 6. The entrained fluid refers to atmospheric air with air pollutants, or hot air or any fluid or gas that needs to be treated accordingly.

The energy at the shaft of the rotating turbine is captured and converted into electrical power by coupling a generator or is consumed for operating other machines (example: pumps, blowers, air compressors) coupled with a shaft of the first aerofoil turbine 6. This is herein termed as 1st stage energy generation.

In another exemplary embodiment of the present disclosure, the system further is used to aerate or add oxygen to the motive fluid/pressurized fluid in order to achieve aerated fluid. In accordance with the exemplary embodiment, a high volume of atmospheric air as an entrained fluid is mixed with the motive fluid which is in a spray form due to the pressurized nature and specialized nozzles. The oxygen from the atmospheric air is absorbed by the motive fluid. A powerful down draft is created by failing motive fluid as air is pushed down the at least one first enclosed chamber 3.

Further, in an embodiment, a discharge end of the at least one first enclosed chamber 3 is connected to at least one second aerofoil turbine 8. The at least one second aerofoil turbine 8 rotates due to the flow of the aerated fluid over the at least one second aerofoil turbine 8, thus enabling 2nd stage of energy generation. Further a second turbine shaft 9 of the at least one second aerofoil turbine 8 is coupled to other machines for their operation. It may also be used to create a closed loop circulation by connecting a pump to suck and pressurize the motive fluid like water from a reservoir for stage 1 of energy generation, this creating a close loop cycle.

Further, the treated fluid are subsequently collected in at least one second enclosed chamber 10 after the fluids have passed through the at least one second aerofoil turbine. The at least one second enclosed chamber 10 is configured to segregate the aerated fluid into the motive fluid and the entrained fluid, and further force them to exit the system via different ports. As the aerated (motive) fluid level rises in the at least one second enclosed chamber 10, the excess motive fluid is accumulated in an overflowing chamber 11 and is released through the motive fluid outlet port 18.

Further, the air/entrained fluid accumulated in the at least one second enclosed chamber 10 is released to atmosphere via a plurality of aerodynamic ports 13. The volume of the entrained fluid accumulating in the at least one second enclosed chamber 10 creates a pressure difference inside the at least one second enclosed chamber 10 with the atmosphere outside. Hence, the velocity of the entrained fluid exiting to atmosphere is high. This creates 3^{rd} stage of energy generation.

In the exemplary embodiment, the at least one second enclosed chamber 10 is connected to a third chamber 12 via the plurality of aerodynamic ports 13. The third chamber 12 comprises a third aerofoil turbine 14 mounted just above the plurality of aerodynamic ports 13 similar to the first aerofoil turbine 6 but in an inverted position.

In the exemplary embodiment, the accumulated air/entrained fluid escapes to the atmosphere with a high velocity via the plurality of aerodynamic ports 13, while in turn rotating/hitting the third aerofoil turbine 14 blades at the outer edge. The kinetic energy of high velocity air is captured by the third aerofoil turbine 14 as it begins to rotate. Energy available at the third turbine shaft 15 is converted to electrical energy by coupling a generator via a gearbox or is used by other machines like pumps or compressors to store the produced energy.

Energy available at the shaft of all the 3 stages is used to further improve system efficiency by coupling additional pumps or blowers or air compressors (without motor) directly the turbine shaft. If pumps are used, additional volume of pressurized motive fluid (water) is available and hence additional enclosed chambers 3 are added to the system. The enclosed chambers 3 further improves the vacuum produced in the second chamber 4 hence further improving energy generation efficiency of all stages along with treatment of fluids.

If air blowers or compressors are connected to turbine shafts, then the inlet port of these air blowers or compressors are connected to the second chamber 4, hence the air blowers or compressors suck out the air and further improve the vacuum produced in the second chambers 4 thereby increasing rotations per minute (RPM) and energy generation efficiency of the first aerofoil turbine 6 of stage 1.

Further in another exemplary embodiment, the third chamber 12 comprises an exhaust fan 16 mounted above the third aerofoil turbine 14. The exhaust fan 16 is preferably operated by an electrical motor 17.

The venturi effects or vacuum produced by the motive fluid is dependent on the differential pressure between the inlet and outlet of the at least one first chamber 3. If back pressure increases—suction (air entrainment) decreases, if back pressure decreases—suction increases. Suction is also reduced if there is turbulence created by entrained air. Drag created by air also reduces spray jet velocity at stage 1 as well as reduces the effect of gravity working on the failing water droplets at stage 2, hence the back pressure and drag results in loss of velocity and kinetic energy.

The exhaust fan 16 reduces back pressure, drag and turbulence of the system thereby increasing the velocity and volume of motive as well as entrained fluid. Increased velocities of motive and entrained fluid increases the kinetic energy available at each stage, thereby highly increasing the energy generation capability of the entire system. As per kinetic energy laws, when velocity doubles, energy (power) increases 8 times. Power consumed by the exhaust fan is regenerated at the first stage itself. A 10% increase in volumetric flow rate of entrained fluid increases energy generation at 1st stage by 30%. Hence, the exhaust fan works as an energy booster or energy multiplier for the system as more energy is generated across 3 stages than the energy consumed by the exhaust fan.

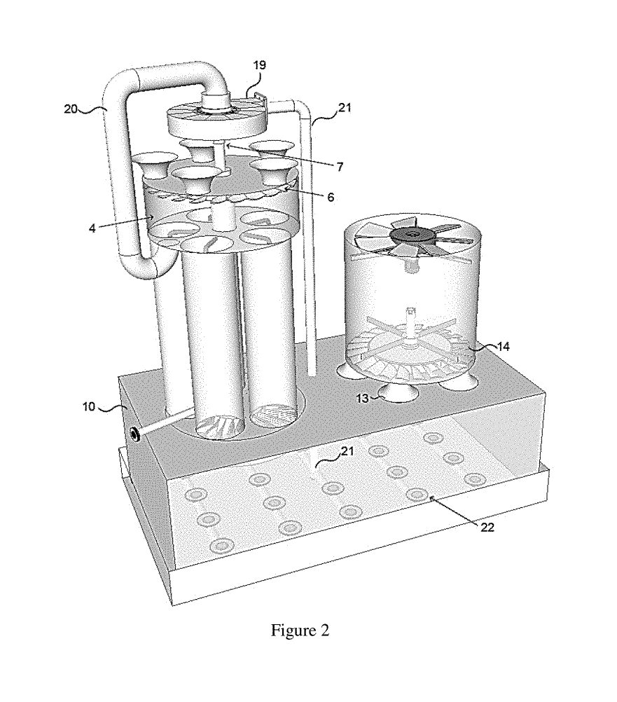

Now referring to FIG. 2, illustrates a system for treatment of a motive fluid, in accordance with the present disclosure. In an embodiment, a bubble aeration process is used to treat the motive fluid/waste water. The entrained fluid in the form of atmospheric air is captured and injected as bubbles using blowers, compressors or venturi injectors. The atmospheric air is injected in a base of a reservoir using bubble diffusers. Since volume of oxygen in air is only 21% and the rest 79% volume is other gases like nitrogen, CO2, energy is wasted to inject these gases in water.

In accordance with the present disclosure, the waste energy from the other gases is effectively recaptured. In an embodiment, an impeller shaft of a blower 19 is coupled with a first turbine shaft 7. A gear assembly is added to manipulate RPM for the blower 19 based on pressure requirement. Further, at least one suction port of the blower 19 is connected to plurality of second chambers 4 via pipe 20. The suction caused by the blower 19 extracts more air from the plurality of second chambers 4 via pipe 20, thus improving the vacuum, and thereby increasing the velocity of the air entering the plurality of second chambers 4 and improving the efficiency of a first aerofoil air turbine 6. The volume of air captured from the plurality of second chambers 4 is pressurized and taken to a bubble diffuser network 22 via pipe 21.

Further, the air injected forms millions of bubbles in the waste water and rises to the surface, while transferring the oxygen to waste water. Further, at least one second enclosed chamber 10 enables creation of a higher pressure in the at least one second enclosed chamber 10 by increasing the volume of air in it. Further, as the air exists the at least one second enclosed chamber 10 via outlet port 13, the waste energy is captured by third aerofoil turbine 14 with increased RPM and Torque.

In another embodiment, if the venturi injectors are used, the suction port of the venturi injectors are connected to the plurality of second chambers 4. This improves the vacuum in the plurality of second chambers 4, and thereby improving efficiency of the first aerofoil air turbine 6.

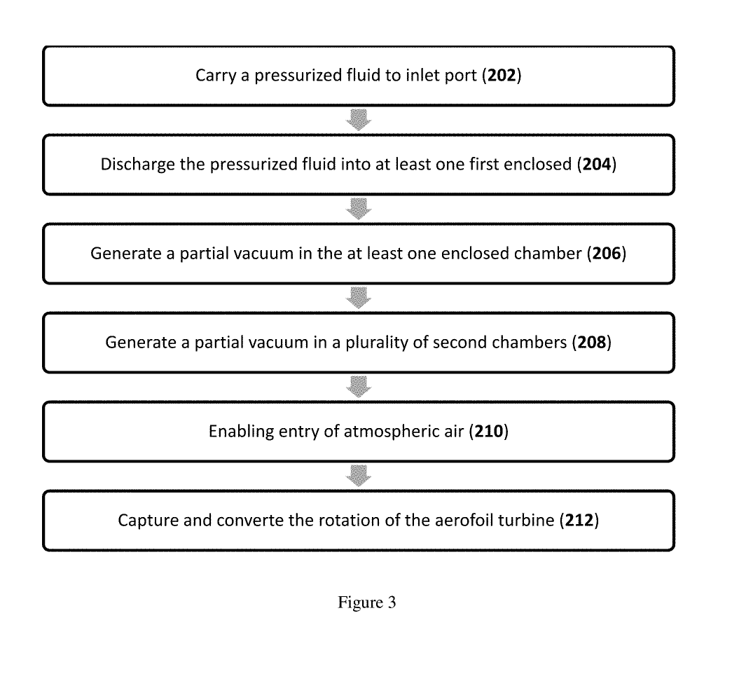

Now referring to FIG. 3, illustrates flow chart of the present system in accordance with the present disclosure. At step 202, a pressurized fluid carried or supplied from a reservoir or from a machine (example: pump) to an inlet port of at least one enclosed chamber. Further, at step 204, discharge of the pressurized fluid occurs over a plurality of nozzle mounted and positioned after the inlet port.

Further at step 206, a partial vacuum is generated in the at least one enclosed chamber. At step 208 another partial vacuum is generated in a plurality of second chambers. The plurality of second chambers is connected via networks of pipes between the at least one first chamber and the second chamber. Further at step 210, atmospheric air is enabled to enter via plurality of inlet ports through an aerofoil turbine, thus simultaneously rotating the aerofoil turbine. Enabling the entry of atmospheric air via plurality of inlet ports enables aerating the pressurized fluid to an aerated fluid. The aerated fluid is allowed to fall under gravity in the at least one first chamber. Further at step 212, the rotation of the aerofoil turbine is captured by and converted for energy generations.

In another embodiment, the aerated fluid is further discharged over a second aerofoil turbine. The rotation of the second aerofoil turbine is captured to generate power. Thus enabling 2nd stage power generation. Further the discharged aerated fluid is accumulated into at least one second chamber. The aerated fluid is separated into air and fluid, and further enables the fluid to accumulate in an overflowing chamber. Further the air is discharged into a third chamber aver a third aerofoil turbine wherein the third aerofoil turbine is mounted in an inverted position with respect to the first aerofoil turbine. The air is further supplied to the third aerofoil via plurality of aerodynamic ports.

I claim:

1) A system for energy generation along with treatment for a motive fluid and an entrained fluid, the system comprising:
at least one first enclosed chamber;
a plurality of nozzles configured to allow flow of the motive fluid into the at least one first enclosed chamber;
a plurality of second chambers connected to the at east one first enclosed chamber through a network of pipes; and
an aerofoil turbine mounted in the plurality of second chambers, wherein the aerofoil turbine it configured to receive the entrained fluid via a plurality of inlets ports positioned on periphery of the aerofoil turbine.

2) The system of claim 1, further comprises at least one second enclosed chamber, positioned downstream from the at least one first enclosed chamber.

3) The system of claim 2, further comprises at least one second aerofoil turbine positioned before the at least one second enclosed chamber.

4) The system of claim 2, wherein the at least one second chamber is configured to segregate the motive fluid and the entrained fluid, allowing the motive fluid to flow into an overflowing chamber.

5) The system of claim 2, further comprises a third chamber connected to the at least one second chamber via a plurality of aerodynamic ports.

6) The system of claim 5, further comprises a third aerofoil turbine mounted in a third chamber, and positioned above the plurality of aerodynamic ports.

7) The system of claim 5, wherein the third aerofoil turbine is inversely mounted with respective to the aerofoil turbine.

8) The system of claim 5, further comprises an exhaust system mounted above the third chamber to reduce back drop pressure.

9) The system of claim 1, further comprises a blower coupled with the aerofoil turbine, wherein at least one suction port of the blower is connected to the plurality of second chambers.

10) A method for treatment of fluids and simultaneous energy generation, the method comprising:
carrying a pressurized motive fluid to inlet port;
discharging the pressurized motive fluid into at least one first enclosed chamber through a plurality of nozzle mounted and positioned after the inlet port;
generating a down draft and partial vacuum in the at least one enclosed chamber;
generating a partial vacuum in a plurality of second chambers connected to the at least one first enclosed chamber through a network of pipes;
enabling entry of an entrained fluid via a plurality of inlet ports while simultaneously rotating an aerofoil turbine; and
capturing and converting the rotation of the aerofoil turbine for energy generation.

11) The method of claim 10, wherein the entering of the entrained fluid further enables treating and aerating the pressurized motive fluid to an aerated fluid falling under gravity in the at least one first chamber.

12) The method of claim 10, further comprises discharging the aerated fluid over a second aerofoil turbine.

13) The method of claim 12, wherein further comprises capturing and generating power from the second aerofoil turbine while discharging the aerated fluid.

14) The method of claim 13, further comprises accumulating the aerated fluid into at least one second chamber.

15) The method of claim 13, further comprises separating the aerated fluid into the entrained fluid and the motive fluid, and enabling the motive fluid to accumulate in an overflowing chamber.

16) The method of claim 13, further comprises discharging the entrained fluid into a third chamber over a third aerofoil turbine wherein the third aerofoil turbine is mounted in an inverted position with respect to the aerofoil turbine.

17) The method of claim 16, wherein the discharging further comprises supplying air to the third aerofoil via plurality of aerodynamic ports.

18) The method of claim 10, wherein generating the partial pressure further comprises creating a suction in the plurality of second chambers using a blower, wherein the blower is coupled with the aerofoil turbine and at least one suction port of the blower is connected to the plurality of second chambers.

19) A system for energy generation along with treatment for a motive fluid and an entrained fluid, the system comprising at least one first enclosed chamber, a plurality of nozzles configured to allow flow of the motive fluid into the at least one first enclosed chamber, a plurality of second chambers connected to the at least one first enclosed chamber through a network of pipes characterized wherein a negative pressure creates a partial vacuum within the plurality of second chambers, and an aerofoil turbine mounted in the plurality of second chambers, wherein the aerofoil turbine is configured to receive the entrained fluid via a plurality of inlets ports positioned on periphery of the aerofoil turbine.

20) The system of claim 19, further comprises a blower wherein the blower is coupled with the aerofoil turbine.

21) The system of claim 19, wherein the plurality of second chambers are connected to at least one suction port of the blower.
